(19) United States
(12) Patent Application Publication
(10) Pub. No.: US 2023/0294128 A1
(43) Pub. Date: Sep. 21, 2023

(54) PRE-COATING PROCESSING METHOD AND PRE-COATING PROCESSING SYSTEM FOR FIBER-REINFORCED THERMOPLASTIC MEMBER

(71) Applicant: MITSUBISHI HEAVY INDUSTRIES, LTD., Tokyo (JP)

(72) Inventors: Hiromichi AKIYAMA, Tokyo (JP); Akihisa OKUDA, Tokyo (JP)

(21) Appl. No.: 18/015,340

(22) PCT Filed: Jan. 21, 2021
(86) PCT No.: PCT/JP2021/001927

§ 371 Date: Jan. 10, 2023

(51) Int. Cl. B05D 3/14; B05D 3/06; B05D 3/08

(52) U.S. Cl. CPC B05D 3/142; B05D 3/062; B05D 3/08

(57) ABSTRACT

The purpose of the present disclosure is to provide a pre-coating processing method and a pre-coating processing system (1) for fiber-reinforced thermoplastic member, which can achieve the coating adherence required in the field of aircraft. In a pre-coating processing method according to the present disclosure, a to-be-coated surface of a fiber-reinforced thermoplastic plastic member (2) is subjected to an activation treatment: in which the to-be-coated surface is activated under a condition such that the surface free energy of the to-be-coated surface immediately after the activation treatment reaches at least 70 mJ/m²; and in which the to-be-coated surface is heated to a temperature at which the modulus of elasticity of the to-be-coated surface becomes lower than that at normal temperature.

### TECHNICAL FIELD

The present disclosure relates to a pre-coating processing method and a pre-coating processing system for a fiber-reinforced thermoplastic member.

### BACKGROUND ART

Currently, a preform of a fiber-reinforced plastic (FRP) mainly used in aircraft is a thermoset resin. The FRP having a thermosetting property requires a long time for molding, and it is difficult to manufacture a large number of components in a short time. Therefore, in recent years, attention has been paid to fiber-reinforced thermoplastics (FRTP) which can be molded in a short time.

When a plastic is coated, in order to improve coating adhesion, a technique for pretreating a surface of a plastic prior to coating is known.

When the plastic is a fiber-reinforced thermoplastic, the fiber-reinforced thermoset is pretreated by means of solvent wiping and sanding.

### CITATION LIST

### Patent Literature

[PTL 1] Japanese Unexamined Patent Application Publication No. 2008-150602

### SUMMARY OF INVENTION

### Technical Problem

When the plastic is the FRTP, even when the pretreatment is performed by means of the solvent wiping and the sanding, in some cases, coating may be peeled off without obtaining required coating adhesion.

PTL 1 discloses a technique for pretreating a surface of thermoplastic by performing atmospheric pressure plasma treatment. However, the thermoplastic disclosed in PTL 1 is a material which is rarely used in structural applications. Therefore, it is unclear whether or not the technique disclosed in PTL 1 can achieve coating adhesion required in a field of aircraft, particularly in structural applications of aircraft.

The present disclosure is made in view of the above-described circumstances, and an object of the present invention is to provide a pre-coating processing method and a pre-coating processing system for a fiber-reinforced thermoplastic member, which can achieve coating adhesion required in a field of aircraft.

### Solution to Problem

In order to solve the above-described problems, a pre-coating processing method and a pre-coating processing system for a fiber-reinforced thermoplastic member of the present disclosure adopts the following means.

According to the present disclosure, there is provided a pre-coating processing method for a fiber-reinforced thermoplastic member. The method includes performing activation treatment on a coating target surface of the fiber-reinforced thermoplastic member before coating. The activation treatment includes activating the coating target surface under a condition that surface free energy of the coating target surface immediately after the activation treatment is 70 mJ/m² or higher, and heating the coating target surface to a temperature at which an elastic modulus of the coating target surface is lowered, compared to an elastic modulus at a normal temperature.

Through the activation, an active functional group is introduced into the coating target surface. When the active functional group is introduced, wettability of the coating target surface is improved. When the wettability is improved, surface free energy increases. The surface free energy of the coating target surface immediately after the activation treatment may be 70 mJ/m² or higher.

When the coating target surface is heated to the temperature at which the elastic modulus is lowered, a movement of a molecular chain on the coating target surface increases. As a result, a further inner side of the fiber-reinforced thermoplastic member is affected by the activation.

When the surface free energy of the coating target surface increases, coating adhesion is improved. During the activation, the coating adhesion is further improved by heating the coating target surface to the above-described temperature.

According to the present disclosure, there is provided a pre-coating processing system which performs surface treatment on a coating target surface of a fiber-reinforced thermoplastic member before coating. The system includes an activation device that activates the coating target surface, a heating device that heats the coating target surface, a temperature measuring device that measures a temperature of the coating target surface, and a control device electrically connected to the activation device, the heating device, and the temperature measuring device. The control device includes a feedback controller that outputs a feedback signal for changing settings of the activation device and the heating device to the activation device and the heating device, based on the temperature obtained by the temperature measuring device.

The control device can change the settings of the activation device and the heating device in accordance with a measurement result of the temperature measuring device. The settings of the activation device and the heating device affect the temperature of the coating target surface in the activation treatment. When the measured temperature does not satisfy a requirement, the temperature of the coating target surface can be adjusted by changing the settings of the activation device and the heating device.

According to the pre-coating processing system disclosed above, the activation treatment can be performed while the temperature is adjusted to satisfy a temperature requirement. Therefore, the coating adhesion of the coating target surface can be significantly improved.

### Advantageous Effects of Invention

During the activation, pre-coating processing is performed by heating the coating target surface to a predetermined temperature. In this manner, coating adhesion required in a field of aircraft can be achieved.

### BRIEF DESCRIPTION OF DRAWINGS

FIG. 1 is a view illustrating a result of an adhesion evaluation test.

FIG. 2 is a view illustrating viscoelasticity measurement data of a CF/LM-PAEK prepreg.

FIG. 3 is a schematic view of a pre-coating processing system according to a second embodiment.

FIG. 4 is a block diagram of a control device. Description of Embodiments

Hereinafter, embodiments of a pre-coating processing method and a pre-coating processing system for a fiber-reinforced thermoplastic member according to the present disclosure will be described.

### FIRST EMBODIMENT

A preform serving as a coating target is a fiber-reinforced thermoplastic (FRTP) member. The preform may be configured to include a single layer of the FRTP or a plurality of layers of the FRTP. The preform may be formed of the FRTP molded by injection molding. The preform may include a thermoplastic film on an outermost surface of the FRTP. The preform may include a lightning strike protection between the FRTP and the thermoplastic film.

The fiber-reinforced thermoplastic includes a reinforcing fiber and a thermoplastic resin. The thermoplastic resin is provided as a matrix.

The thermoplastic resin is not particularly limited, and may be a super engineer plastic such as polyaryl ether ketone (PAEK), polyphenylene sulfide (PPS), polyetherimide (PEI), and liquid crystal polymer (LCP). For example, the PAEK is polyether ether ketone (PEEK), polyether ketone ketone (PEKK), or low melting point PAEK (LM PAEK).

The reinforcing fiber may be an inorganic fiber or an organic fiber. Examples of the inorganic fiber include a carbon fiber (CF), a glass fiber, and a silicon carbide fiber. Examples of the organic fiber include an aramid fiber, a polyparaphenylene benzobis oxazole (PBO) fiber, a polyallylate fiber, and a PEEK fiber.

The reinforcing fiber may be in a form of a unidirectionally oriented fiber sheet, a fabric, and a nonwoven fabric. The reinforcing fiber may be a short fiber carbon fiber, a carbon nanotube, and a carbon nanofiber, or may be in a form used for injection molding in which these materials are mixed with a resin.

The thermoplastic film may be formed of the same resin as that of the matrix.

The lightning strike protection (LSP) is a copper mesh, an aluminum mesh, a copper foil, or an aluminum foil.

In a pre-coating processing method according to the present embodiment, activation treatment is performed on a coating target surface of the preform serving as a coating target before coating. In the activation treatment, the coating target surface is activated and heated.

The “activation” means that an active functional group causing chemical bond is introduced. Since the active functional group is introduced, surface free energy of the coating target surface increases (wettability is improved).

A method for the activation includes plasma treatment, ultraviolet (UV) treatment, vacuum ultraviolet (VUV) treatment, and flame treatment.

For example, in a case of the activation by the plasma treatment, a plasma irradiation device using a known plasma generation technique can be used. It is desirable to perform plasma irradiation on a large component (member) with an atmospheric pressure plasma irradiation device. The plasma irradiation on a small member may be performed by a decompression plasma irradiation device.

The plasma is formed of any desired gas. For example, the plasma may be formed of at least one of substances which are gasified at a normal temperature, such as air, oxygen, nitrogen, carbon dioxide, oxygen, nitrogen, steam, helium, neon, and argon.

The active functional group introduced by irradiating the member with the plasma containing oxygen is a hydroxy group, a carboxy group, or a carbonyl group. Since a type of the plasma used for irradiation is selected, it is possible to manage a type of the functional group to be introduced.

In the present embodiment, the coating target surface is activated under a condition that the surface free energy immediately after the activation treatment is 70 mJ/m² or higher. The condition that the surface free energy is 70 mJ/m² or higher may be set in advance by a preliminary test. The term “immediately after” allows a work time needed to obtain information for calculating the surface free energy of the coating target surface after the activation treatment. The surface free energy of the coating target surface decreases with the lapse of time after the activation treatment. Therefore, it is desirable to set a shorter time from an end time point of the activation treatment to a start time point of work for obtaining the above-described information. For example, as a guide, the term “immediately after” means approximately 5 minutes after the activation treatment ends.

During the activation treatment, the coating target surface is heated to a temperature at which an elastic modulus (storage modulus) is lowered, compared to an elastic modulus at a normal temperature. When the elastic modulus at the normal temperature is set as 100%, a reduction range of the elastic modulus of the coating target surface due to heating is preferably 5% or larger, and is more preferably 10% or larger. The “normal temperature” is a temperature in a state before heating. More specifically, the “normal temperature” is 40° C. or lower.

It is preferable that the temperature of the coating target surface during heating is kept within a temperature range in which a material of the coating target surface does not deteriorate. The “deterioration” means that the reinforcing fiber is exposed from the coating target surface, irregularities are significantly formed, compared to the coating target surface before heating, or a surface color is remarkably changed to such an extent that the change can be visually confirmed.

In the activation treatment, it is preferable to measure the temperature of the coating target surface, and to confirm that the coating target surface reaches a desired temperature. A condition that the coating target surface can be heated to the desired temperature may be set in advance by a preliminary test.

Next, an operational effect of the pre-coating processing in the above-described embodiment will be described.

### Preparation of Preform

Preform X: CF/LM-PAEK panel (without film)
Preform Y: CF/LM-PAEK panel (with film)
Preform Z: CF/LM-PAEK panel (with lightning strike protection + film)

A low melting point PAEK film (thickness 60 µm) is used as a film.

A copper mesh (DEXMET Expand Cu foil) is used as the lightning strike protection (LSP).

The preform X is produced by solidifying a prepreg in which CF is impregnated with PAEK.

The preform Y is produced by superimposing a low melting point PAEK film on a prepreg in which CF is impregnated with PAEK and integrally solidifying the materials.

The preform Z is produced by sequentially superimposing the lightning strike protection and the low melting point PAEK film on the prepreg in which CF is impregnated with PAEK and integrally solidifying the materials.

### Surface Treatment

Surfaces of the preform X to the preform Z are cleaned by wiping with a solvent, and thereafter, surface treatment is performed by either atmospheric pressure plasma treatment or sanding. The preform which is cleaned only without the surface treatment is regarded as “untreated”.

The solvent used for cleaning is methyl ethyl ketone (MEK). Alternatively, acetone, IPA, or ethanol can be used depending on contaminated species.

The atmospheric pressure plasma treatment is performed under a condition that a distance (gap) from a tip of a plasma nozzle to a surface of the preform is 5 mm to 30 mm, a nozzle moving speed is 40 mm/s, the treatment is performed once, and a heater is turned on. The gap is a distance from a tip of a nozzle that irradiates the surface with the plasma to a surface of a specimen. The speed is a moving speed of the nozzle.

A thermocouple is installed on the surface of the preform, and a surface temperature of the preform is measured during the atmospheric pressure plasma treatment.

The sanding is performed until the surface is visually dull.

### Surface Free Energy

Immediately after the surface treatment, a contact angle of water and diiodomethane is measured on a treated surface (surface which is untreated but cleaned) of the preform. A contact angle meter (PCA-1 manufactured by Kyowa Surface Science Co., Ltd.) is used for measuring the contact angle.

The surface free energy (SFE) is calculated from a formula of Owens-Wendt by using a measurement result of the contact angle.

### Coating

Coating is performed on the treated surface of the preform (surface which is untreated but cleaned).

An epoxy coating material (Epoxy Primer 37035A manufactured by AkzoNobel N.V.) is used for the coating. The epoxy coating material is applied to the surface of the preform X to the surface of the preform Z with a heavy-duty spray gun, and is naturally dried for seven days.

### Adhesion Evaluation Test

The preform X to the preform Z which are coated will be referred to as a specimen X to a specimen Z.

As the specimen X to the specimen Z, a normal state (dry) where the specimens are naturally dried after the coating and a wet state (wet) where the specimens are soaked in distilled water for seven days after the specimens are naturally dried are prepared.

An adhesion evaluation test of a coating film is performed in compliance with an ISO2409 (JIS K5600-5-6) cross-cut method by using the specimen X to the specimen Z (dry or wet).

In the cross-cut method, first, a cutout in a lattice pattern is formed on coating surfaces of the specimen X to the specimen Y. Thereafter, a tape is affixed to the coating surface, and the tape is detached at a predetermined angle within a prescribed time. Then, a state of a cross-cut portion where the coating is peeled off on the surface of the specimen after the tape is detached is evaluated.

The evaluation is classified into a class 0 to a class 5.

Class 0: an edge of the cut is completely smooth, and the coating in meshes of any lattice is not peeled off.

Class 1: the coating film is peeled off a little bit at an intersection of the cut. An affected portion in the cross-cut portion does not clearly exceed 5%.

Class 2: the coating film is peeled off along an edge of the cut and/or at the intersection. An affected portion in the cross-cut portion clearly exceeds 5%, but does not exceed 15%.

Class 3: the coating film is partially or entirely scaled along the edge of the cut, and/or various portions of the meshes are partially or entirely peeled off. An affected portion in the cross-cut portion clearly exceeds 15%, but does not exceed 35%.

Class 4: the coating film is partially or entirely scaled along the edge of the cut, and/or some meshes are partially or entirely peeled off. An affected portion in the cross-cut portion does not clearly exceed 35%.

Class 5: the coating film is somewhat peeled off to such an extent that the change cannot be classified even with the class 4.

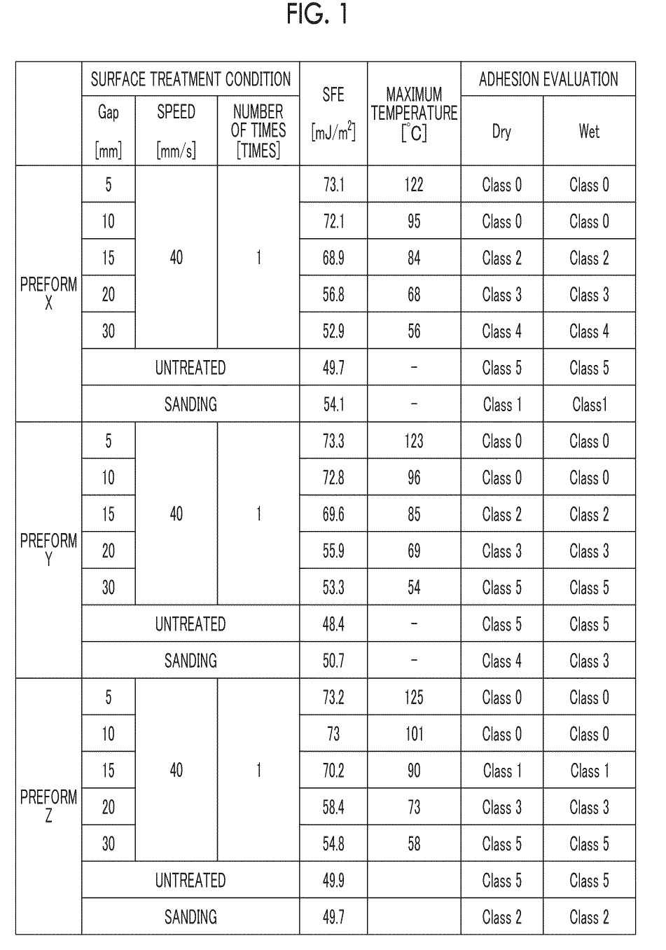

FIG. 1 illustrates the preform of each specimen, a surface treatment condition, a maximum temperature of the treated surface during atmospheric pressure plasma treatment, the surface free energy of the treated surface immediately after the surface treatment, and a result of the adhesion evaluation test.

When the results of the adhesion evaluation correspond to class 0 to class 1, the surface treatment condition (pre-coating processing condition) can be applied to a structural member of aircraft.

When the preform X to the preform Z which are untreated are used, both the dry specimen and the wet specimen correspond to class 5.

In the specimens using the preform X to the preform Z which are subjected to the surface treatment by sanding, the results of the adhesion evaluation vary depending on a configurations of the preform.

When the preform Y including only the film is used, the dry specimen corresponds to class 4, and the wet specimen corresponds to class 3.

When the preform Z including the lightning strike protection and the film is used, both the dry specimen and the wet specimen correspond to class 2. The reason is considered as follows. A lightning strike protection mesh is partially exposed on the surface through the sanding.

When the preform X which does not include the film is used, both the dry specimen and the wet specimen correspond to class 1. It is estimated that adhesion in the preform X is improved since the reinforcing fiber is exposed on the surface of the preform through the sanding. Even when the adhesion of the coating is improved, the exposure of the reinforcing fibers is not preferable in terms of strength.

In the specimen using the preform subjected to atmospheric pressure plasma treatment, the adhesion is improved as the gap is smaller, regardless of the configuration of the preform.

In the specimen in which the adhesion evaluation corresponds to class 0 or class 1, the following is confirmed. The heating is performed under a condition that the surface free energy of the treated surface is 70 mJ/m² or higher, and the maximum temperature of the treated surface during the atmospheric pressure plasma treatment is 90° C. or higher. In particular, in the specimen in which the adhesion evaluation corresponds to class 0, the maximum temperature of the treated surface during the atmospheric pressure plasma treatment exceeds 95° C.

### Elastic Modulus

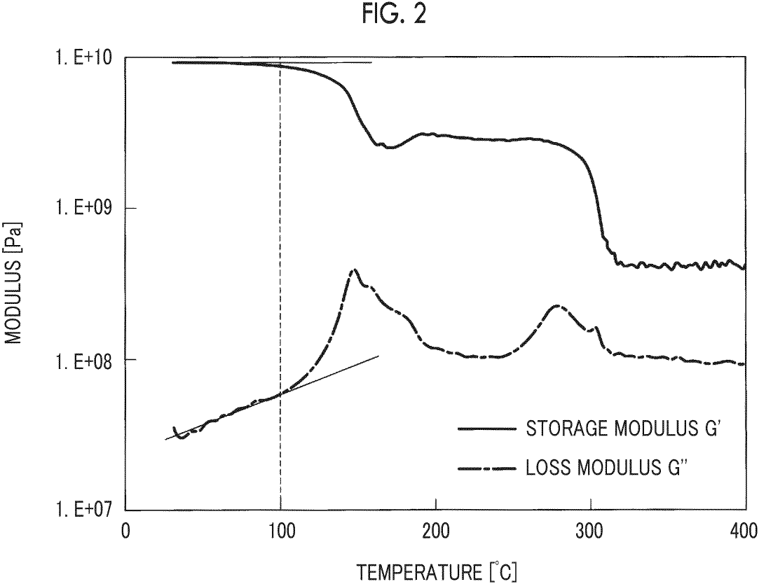

FIG. 2 illustrates viscoelasticity measurement data of the CF/LM-PAEK prepreg. In the drawing, a vertical axis represents an elastic modulus (Pa), a horizontal axis represents a temperature (°C), a solid line represents a storage modulus G′, and a one-dot chain line represents a loss modulus G″. The CF/LM-PAEK prepreg is a prepreg in which CF is impregnated with LM-PAEK.

The storage modulus G′ and the loss modulus G″ are obtained under a condition that a temperature increase rate is 5° C./min and a frequency is 1 Hz.

According to FIG. 2, the storage modulus G′ (elastic modulus) of the CF/PAEK prepreg tends to decrease as the temperature increases. In a case of using the elastic modulus at a normal temperature as a reference (100%), the elastic modulus decreases by approximately 5% when heated to 90° C., and the elastic modulus decreases by approximately 10% when heated to 100° C.

According to the results in FIGS. 1 and 2, the elastic modulus of the preform is lowered by heating the preform. In this manner, a movement of a molecular chain increases, and it is estimated that an advantageous effect is internally achieved by the activation.

According to the above-described configuration, the following is suggested. The coating target surface whose adhesion is improved can be achieved by activating the surface of the preform and heating the surface of the preform to the temperature at which the elastic modulus is lowered.

### SECOND EMBODIMENT

In addition to the first embodiment, a pre-coating processing method according to the present embodiment includes a step of measuring the temperature of the coating target surface during the activation treatment, and changing activation and heating conditions, based on the temperature obtained by the measurement.

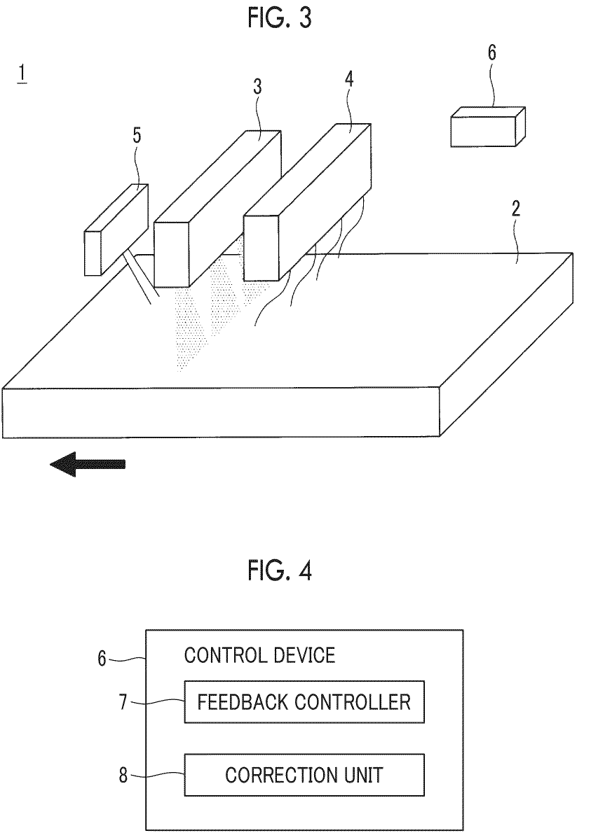

FIG. 3 illustrates a schematic view of a pre-coating processing system according to the present embodiment. A pre-coating processing system 1 processes the coating target surface of a fiber-reinforced thermoplastic member 2 before coating.

The pre-coating processing system 1 includes an activation device 3, a heating device 4, a temperature measuring device 5, and a control device 6.

The activation device 3 has means for activating the coating target surface of the fiber-reinforced thermoplastic member 2 (preform serving as a coating target) . The activation device 3 is a plasma irradiation device, an ultraviolet irradiation device, a vacuum ultraviolet irradiation device, or a flame radiation device.

The heating device 4 has means for heating the coating target surface. The heating device 4 is a hot air heater, an infrared heater, or a far-infrared heater. The heating device 4 is installed to be capable of heating the coating target surface in an area to be activated in parallel with the activation in the activation device 3 or prior to the activation in the activation device 3.

The temperature measuring device 5 has a sensor that measures the temperature of the coating target surface. The temperature measuring device 5 may adopt a contactless type. The temperature measuring device 5 adopting the contactless type is a radiation temperature sensor.

The temperature measuring device 5 in FIG. 3 adopts the contactless type. The temperature measuring device 5 adopting the contactless type is suitable for a system in which the temperature of the coating target surface (treatment target surface) cannot be directly measured.

The temperature measuring device 5 is installed to be capable of measuring the temperature of the coating target surface in an area to be activated in parallel with the activation in the activation device 3 or prior to the activation in the activation device 3.

For example, the control device 6 is configured to include a central processing unit CPU), a random access memory (RAM), a read only memory (ROM), and a computer-readable storage medium. As an example, a series of processes for realizing various functions are stored in a storage medium in a form of a program. The CPU reads the program in the RAM, and executes information processing and arithmetic processing. In this manner, various functions are realized. The program may adopt a form in which the program is installed in advance in the ROM or another storage medium, a form in which the program is provided in a stored state in a computer-readable storage medium, or a form in which the program is delivered via wired or wireless communication means. The computer-readable storage medium is a magnetic disc, a magneto-optical disc, a CD-ROM, a DVD-ROM, or a semiconductor memory.

The control device 6 is electrically connected to the activation device 3, the heating device 4, and the temperature measuring device 5. The control device 6 has a feedback controller 7 (refer to FIG. 4).

The feedback controller 7 receives the temperature obtained by the temperature measuring device 5, and based on the temperature, the feedback controller 7 outputs a feedback signal for changing the settings of the activation device 3 and the heating device 4 to the activation device 3 and the heating device 4.

For example, when the activation device 3 is the plasma irradiation device, the feedback controller 7 changes the settings of a distance (gap) between a plasma nozzle (activating means) and the coating target surface, a moving speed of the plasma nozzle, and a heating temperature of the heating device 4.

When the temperature obtained by the temperature measuring device 5 is lower than a predetermined temperature, the feedback controller 7 changes the settings of the activation device 3 and the heating device 4 so that the temperature of the coating target surface falls within a predetermined temperature range.

When the temperature obtained by the temperature measuring device 5 exceeds the predetermined temperature, the feedback controller 7 changes the settings of the activation device 3 and the heating device 4 so that the temperature of the coating target surface falls within the predetermined temperature range.

The predetermined temperature is a temperature at which the elastic modulus of the coating target surface is lowered, compared to the elastic modulus at the normal temperature. A reduction range of the elastic modulus is preferably 5% or larger, and is more preferably 10% or larger. The predetermined temperature is more preferably a temperature at which a material of the coating target surface does not deteriorate.

In FIG. 3, the pre-coating processing system 1 is fixed, and the fiber-reinforced thermoplastic member 2 moves in a direction of an arrow. Without being limited thereto, the pre-coating processing system 1 may move, and the fiber-reinforced thermoplastic member 2 may be fixed. Alternatively, both the pre-coating processing system 1 and the fiber-reinforced thermoplastic member 2 may be movable.

The heating device 4 may be integrated with activating means of the activation device 3.

When the temperature measuring device 5 adopts the contactless type, the control device 6 may include a correction unit 8 in addition to the feedback controller 7 (refer to FIG. 4).

The correction unit 8 corrects the temperature obtained by the temperature measuring device 5 adopting the contactless type, and outputs the corrected temperature signal to the feedback controller 7.

The correction unit 8 stores correlation data in which the temperature measured by the temperature measuring device adopting a contact type and the temperature measured by the temperature measuring device adopting the contactless type are associated with each other. The correlation data can be acquired in advance by a preliminary test. The correction unit 8 regards the temperature measured by the temperature measuring device adopting the contact type as a true temperature, and corrects the temperature obtained by the temperature measuring device 5 adopting the contactless type, based on the correlation data.

In addition, the control device 6 may include a temperature estimation unit (not illustrated) in addition to or instead of the correction unit 8. The temperature estimation unit stores correlation data between a material of the preform and the amount of energy needed to change the material by 1° C. The correlation data can be acquired in advance by a preliminary test. The temperature estimation unit receives an activation condition in the activation device 3 and a heating condition in the heating device 4, and estimates the temperature of the coating target surface, based on each of the received conditions. The temperature estimation unit functions as a substitute for the temperature measuring device 5. Therefore, the temperature measurement of the temperature measuring device 5 may be omitted.

The feedback controller 7 outputs a feedback signal for changing the settings of the activation device 3 and the heating device 4 to the activation device 3 and the heating device 4, based on the estimated temperature obtained by the temperature estimation unit.

The temperature estimation unit is effectively used when a predetermined allowable temperature range of the coating target surface is sufficiently wide as a result of the temperature measurement in advance.

In addition, when the predetermined temperature range of the coating target surface can be set to be sufficiently wide, the control device 6 may include a temperature controller (not illustrated) in addition to or instead of the correction unit 8. The temperature controller stores an activation treatment program and a heating program for keeping the temperature of the coating target surface within a predetermined range. The activation treatment program and the heating program can be constructed from data acquired in advance by a preliminary test.

For example, when the activation device 3 is the plasma irradiation device, in the activation treatment program and the heating program, the distance between the plasma nozzle and the coating target surface, the moving speed of the plasma nozzle (or the preform), and the heating temperature of the heating device 4 are set every time.

The temperature controller changes setting conditions of the activation device 3 and the heating device 4 in accordance with the activation treatment program and the heating program. The temperature controller functions as a substitute for the temperature measuring device 5. Therefore, the temperature measurement of the temperature measuring device 5 may be omitted.

The control device 6 including the temperature controller may further include a notification unit (not illustrated). The notification unit notifies a worker of an error when the distance between the plasma nozzle and the coating target surface, the speed, plasma performance, and the heating temperature deviate from requirements (when deviating from programmed conditions). The worker who recognizes the error can change the settings of the activation device 3 and/or the heating device 4 by using an external input or manually.

### Additional Notes

The pre-coating processing method and the pre-coating processing system for the fiber-reinforced thermoplastic member according to the embodiments described above are understood as follows, for example.

According to the present disclosure, there is provided a pre-coating processing method for a fiber-reinforced thermoplastic member (2). The method includes performing activation treatment on a coating target surface of the fiber-reinforced thermoplastic member before coating. The activation treatment includes activating the coating target surface under a condition that surface free energy of the coating target surface immediately after the activation treatment is 70 mJ/m² or higher, and heating the coating target surface up to a temperature at which an elastic modulus of the coating target surface is lower than an elastic modulus at a normal temperature.

Through the activation, an active functional group is introduced into the coating target surface. When the active functional group is introduced, wettability of the coating target surface is improved. When the wettability is improved, surface free energy increases. The surface free energy of the coating target surface immediately after the activation treatment may be 70 mJ/m² or higher.

When the coating target surface is heated to the temperature at which the elastic modulus is lowered, a movement of a molecular chain on the coating target surface increases. As a result, a further inner side of the fiber-reinforced thermoplastic member is affected by the activation.

When the surface free energy of the coating target surface increases, coating adhesion is improved. During the activation, the coating adhesion is further improved by heating the coating target surface to the above-described temperature.

It is preferable that the temperature is a temperature at which a reduction range of the elastic modulus due to the heating is 5% or higher, compared to 100% of the elastic modulus of the coating target surface at the normal temperature. It is preferable that a reduction range is 10% or larger.

As the reduction range increases, a movement of a molecular chain increases. Therefore, a range affected by the activation is widened.

In the fiber-reinforced thermoplastic member, a reinforcing fiber may be a carbon fiber, and a preform may be a low melting point polyaryl ether ketone (LM-PAEK). During the heating, it is preferable that the heating is performed on the coating target surface until the temperature of the coating target surface reaches 90° C. or higher.

While the coating target surface is activated under a condition that the surface free energy of the coating target surface is 70 mJ/m² or higher, the coating target surface is heated to reach 90° C. or higher. In this manner, coating adhesion satisfying a required value for an application to aircraft is more reliably achieved.

In one aspect of the above-described disclosure, in the activation treatment, the temperature of the coating target surface is measured. When the temperature of the coating target surface does not reach a temperature at which the elastic modulus of the coating target surface is lowered, compared to the elastic modulus at the normal temperature, based on the temperature obtained by the measurement, a condition for activating the coating target surface and a condition for the heating can be changed to reach a temperature at which the elastic modulus of the coating target surface is lowered, compared to the elastic modulus at the normal temperature.

In the activation treatment, the temperature of the coating target surface is measured, and the condition for activating the coating target surface and the condition for the heating can be changed, based on the temperature obtained by the measurement. In this manner, the temperature of the coating target surface can be more reliably managed.

In one aspect of the above disclosure, correlation data in which a temperature measured by a temperature measuring device adopting a contact type and a temperature measured by a temperature measuring device adopting a contactless type are associated with each other is prepared in advance. In the activation treatment, the temperature of the coating target surface is measured by the contactless type temperature measuring device, and the temperature obtained by the temperature measuring device is corrected, based on the correlation data. The condition for activating the coating target surface and the condition for the heating can be changed, based on the corrected temperature.

When the temperature measuring device adopting the contactless type is used, there is a possibility that a deviation may occur between a true temperature of the coating target surface of the fiber-reinforced thermoplastic member and a measurement value. The temperature can be guaranteed by correcting the temperature by using the correlation data.

According to the present disclosure, there is provided a pre-coating processing system (1) which performs surface treatment on a coating target surface of a fiber-reinforced thermoplastic member (2) before coating. The system includes an activation device (3) that activates the coating target surface, a heating device (4) that heats the coating target surface, a temperature measuring device (5) that measures a temperature of the coating target surface, and a control device (6) electrically connected to the activation device, the heating device, and the temperature measuring device. The control device includes a feedback controller (7) that outputs a feedback signal for changing settings of the activation device and the heating device to the activation device and the heating device, based on the temperature obtained by the temperature measuring device.

The control device can change the settings of the activation device and the heating device in accordance with a measurement result of the temperature measuring device. The settings of the activation device and the heating device affect the temperature of the coating target surface in the activation treatment. When the measured temperature does not satisfy a requirement, the temperature of the coating target surface can be adjusted by changing the settings of the activation device and the heating device.

According to the pre-coating processing system disclosed above, the activation treatment can be performed while the temperature is adjusted to satisfy a temperature requirement. Therefore, coating adhesion of the coating target surface can be more reliably improved.

In one aspect of the above disclosure, the temperature measuring device adopts a contactless type. The control device includes a correction unit (8) that corrects the temperature obtained by the temperature measuring device adopting the contactless type and outputs a corrected temperature signal to the feedback controller. The correction unit can correct the temperature obtained by the temperature measuring device adopting the contactless type, based on correlation data in which the temperature measured by the temperature measuring device adopting the contact type and a temperature measured by a temperature measuring device adopting a contactless type are associated with each other.

Even when a measurement value of the temperature measuring device adopting the contactless type deviates from a true temperature, the correction unit can guarantee the temperature by correcting the temperature, based on the correlation data.

### REFERENCE SIGNS LIST

1: Pre-coating processing system
2: Fiber-reinforced thermoplastic member
3: Activation device
4: Heating device
5: Temperature measuring device
6: Control device
7: Feedback controller
8: Correction unit

1. A pre-coating processing method for a fiber-reinforced thermoplastic member, the method comprising:
performing activation treatment on a coating target surface of the fiber-reinforced thermoplastic member before coating,
wherein the activation treatment includes
activating the coating target surface under a condition that surface free energy of the coating target surface immediately after the activation treatment is 70 mJ/m² or higher, and
heating the coating target surface to a temperature at which an elastic modulus of the coating target surface is lowered, compared to an elastic modulus at a normal temperature.

2. The pre-coating processing method for a fiber-reinforced thermoplastic member according to claim 1,
wherein the temperature is a temperature at which a reduction range of the elastic modulus due to the heating is 5% or larger, compared to 100% of the elastic modulus of the coating target surface at the normal temperature.

3. The pre-coating processing method for a fiber-reinforced thermoplastic member according to claim 1,
wherein in the fiber-reinforced thermoplastic member, a reinforcing fiber is a carbon fiber, and a preform is a low melting point polyaryl ether ketone, and
during the heating, the heating is performed on the coating target surface until the temperature of the coating target surface reaches 90° C. or higher.

4. The pre-coating processing method for a fiber-reinforced thermoplastic member according to claim 1,
wherein in the activation treatment, a temperature of the coating target surface is measured, and
when the temperature of the coating target surface does not reach the temperature at which the elastic modulus of the coating target surface is lowered, compared to the elastic modulus at the normal temperature, based on the temperature obtained by the measurement, a condition for activating the coating target surface and a condition for the heating are changed to reach the temperature at which the elastic modulus of the coating target surface is lowered, compared to the elastic modulus at the normal temperature.

5. The pre-coating processing method for a fiber-reinforced thermoplastic member according to claim 4,
wherein correlation data in which a temperature measured by a temperature measuring device adopting a contact type and a temperature measured by a temperature measuring device adopting a contactless type are associated with each other is prepared in advance,
the activation treatment includes
measuring the temperature of the coating target surface by the temperature measuring device adopting the contactless type,
correcting the temperature obtained by the temperature measuring device, based on the correlation data, and
changing the condition for activating the coating target surface and the condition for the heating, based on the corrected temperature.

6. A pre-coating processing system which performs surface treatment on a coating target surface of a fiber-reinforced thermoplastic member before coating, the system comprising:
an activation device that activates the coating target surface;
a heating device that heats the coating target surface;
a temperature measuring device that measures a temperature of the coating target surface; and
a control device electrically connected to the activation device, the heating device, and the temperature measuring device,
wherein the control device includes a feedback controller that outputs a feedback signal for changing settings of the activation device and the heating device to the activation device and the heating device, based on the temperature obtained by the temperature measuring device.

7. The pre-coating processing system according to claim 6,
wherein the temperature measuring device adopts a contactless type,
the control device includes a correction unit that corrects the temperature obtained by the temperature measuring device adopting the contactless type and outputs a corrected temperature signal to the feedback controller, and
the correction unit corrects the temperature obtained by the temperature measuring device adopting the contactless type, based on correlation data in which a temperature measured by the temperature measuring device adopting a contact type and a temperature measured by the temperature measuring device adopting the contactless type are associated with each other.
